(19) United States
(12) Patent Application Publication
(10) Pub. No.: US 2006/0235808 A1
(43) Pub. Date: Oct. 19, 2006

(54) SYSTEM FOR MANAGING RECYCLABLE AND NON-RECYCLABLE MATERIALS

(76) Inventor: Matthew P. Berry, Columbus, OH (US)

Correspondence Address: MCNEES, WALLACE & NURICK LLC, 100 PINE STREET, P.O. BOX 1166, HARRISBURG, PA, 17108-1166, US

(21) Appl. No.: 11/422,215

(22) Filed: Jun. 5, 2006

Related U.S. Application Data
(63) Continuation-in-part of application No. 10/789,155, filed on Feb. 27, 2004.
Application No. 10/789,155 is a continuation of application No. 09/867,858, filed on May 30, 2001, now abandoned.

(51) Int. Cl. G06F 17/00

(52) U.S. Cl. 705/414

(57) ABSTRACT

A systematic method for managing recyclable and non-recyclable waste. The method includes the step of identifying an amount of recyclable waste. The method also includes the step of determining a credit amount based on the amount of recyclable waste. The method further includes the step of reporting the credit amount to the customer. A container for use in a recycling system is also described. The container may include a structure for containing recyclable waste; and indicia may be disposed on the structure. The indicia identify the value of the recyclable waste contained by the structure.

### CROSS-REFERENCE TO RELATED APPLICATIONS

This patent application is a continuation-in-part of U.S. patent application Ser. No. 10/789,155 filed on Feb. 27, 2004 and entitled “Method and System for Collecting Recyclable Waste”, which was a continuation of U.S. patent application Ser. No. 09/867,858, filed on May 30, 2001, now abandoned.

### BACKGROUND OF THE INVENTION

The described system and method are generally related to separating solid materials and assorting or segregating them in grades or classes according to physical characteristics. More specifically, the described method and system relate to segregating recyclable materials into readily identifiable units, the market value of which may be determined.

Recycling household and commercial waste has a number of benefits. Recycling conserves natural resources by substituting “secondary resources”, including paper, glass and metal for original natural resources. It also extends the useful life of landfills, which would otherwise contain materials that could be productively reused. According to the U.S. Environmental Protection Agency (“EPA”), in the early 1980's only one curbside recycling program was operating in the United States. By 1997, more than 9,000 curbside programs were operating and there were more than 12,000 recyclable drop-off centers nationwide. Further, 380 materials recovery facilities were in operation by 1997 to process the collected materials.

Despite voluntary, community-based recycling programs, and despite the nation's general awareness of recycling and its benefits, many households and businesses fail to recycle, or recycle only a fraction of their potentially recyclable waste. This failure to adequately recycle is an increasing problem because the United States produces vast amounts of trash. According to the EPA, in 1997 the U.S. generated 217 million tons of municipal solid waste (“MSW”). In human terms, the average person generated 4.3 pounds of trash per day. That represents a 138% increase from 1960 at which time each person generated an average of 2.7 pounds, an increase of 5.11% per year.

Approximately 55% of all MSW is land filled, with 2,514 landfills operating across the country on a daily basis. 17% of all MSW is incinerated. The remaining 27% is recycled. Between 1990 and 1995, recycling increased a total of 20% or 3.33% per year, mostly due to the increased number of community curbside recycling programs. Such increases, however, have been outstripped by the shear increase in MSW. The ever-expanding economy continues to drive the purchase of more and more packaged goods and services. Thus, for 1997 there continued to be a net loss to disposal versus recycling of 1.78%. In other words, it is expected that regardless of all of the community-based efforts, the U.S. national MSW output will continue to increase approximately 1.78% per year. While recycling efforts to date have slowed the expansion of MSW, the trash problem continues to grow.

Consequently, a need exists for an improved method and system for recycling waste that encourages increased household and business participation in a recycling program. A need further exists for an improved method and system for recycling waste that financially rewards recycling participation. Yet another need exists for an improved method and system that enables identification, trading and selling of collected bundles or units of recyclable waste.

### SUMMARY OF THE INVENTION

According to a first aspect of the present invention, a method for billing a customer for trash collection is described. This method includes the step of identifying a quantifiable amount of recyclable waste. The method also includes the step of determining a credit amount based on the amount of recyclable waste. The method further includes the step of reporting the credit amount to the customer.

According to a second aspect of the present invention, a container is described for use in a recycling system. The container comprises a structure for containing recyclable waste. The container further comprises indicia disposed on the structure. The indicia identify the value or other characteristics of the recyclable waste, which may be contained within the structure.

According to a third aspect of the present invention, an apparatus is disclosed for billing a consumer for trash collection. The apparatus comprises a processor and a memory. The processor and memory are connected, and the memory stores a program to control the operation of the processor. The processor is operative with the program in the memory to receive a first amount representing an amount of trash identified as non-recyclable. The processor is further operative with the program in the memory to receive a second amount representing an amount of trash identified as recyclable. The processor is still further operative with the program in the memory to apply a charge based on the first amount and apply a credit based on the second amount. The processor then reports the charge and credit to the customer for payment or credit according to the program in the memory.

According to a fourth aspect of the present invention, a computer-readable storage medium is described. The medium is encoded with processing instructions for implementing method for billing a consumer for trash collection. The processing instructions direct a computer to determine a first amount representing an amount of trash identified as non-recyclable. The processing instructions also direct a computer to determine a second amount representing an amount of trash identified as recyclable. The program instructions further direct a computer to apply a charge based on the first amount and apply a credit based on the second amount. The program instructions finally direct a computer to report the charge and credit to the customer for payment or credit.

According to a fifth aspect of the present invention, a comprehensive system and method for profitably managing recyclable and non-recyclable materials is described. This system, and the associated method, includes at least one customer, typically a home or business owner; at least one source of recyclable materials of at least one type, such as, for example, paper, plastic, metal, or glass generated in a home or place of business; a unit-based system for sorting the recyclable materials by type; and a system administrator for collecting, weighing, valuing, processing recyclable and non-recyclable materials, and crediting or debiting a customer account created for a user of the system.

Additional features and aspects of the present invention will become apparent to those of ordinary skill in the art upon reading and understanding the following detailed description of the exemplary embodiments. As will be appreciated, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a schematic block diagram illustrating the environment of an embodiment of the described method and system;

FIG. 2 is a pictorial view of the point of collection in one embodiment of the present invention;

FIG. 3 is a functional flow diagram illustrating the primary steps employed according to the method of the present invention; and

FIG. 4 is a functional flow diagram illustrating an embodiment of the present invention that includes a system administrator entity or entities.

### DETAILED DESCRIPTION OF THE INVENTION

Exemplary embodiments of the present invention are now described with reference to the Figures. Reference numerals are used throughout the detailed description to refer to the various elements and structures. In other instances, well-known structures and devices are shown in block diagram form for purposes of simplifying the description. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention. Certain terminology is used in the following description for convenience only and is not meant to limit the scope of the invention or aspects thereof. The word “a,” as used in the claims and in corresponding portions of the specification, means “at least one.” The terminology includes the words noted above, derivatives thereof and words of similar import.

Recycling Environment

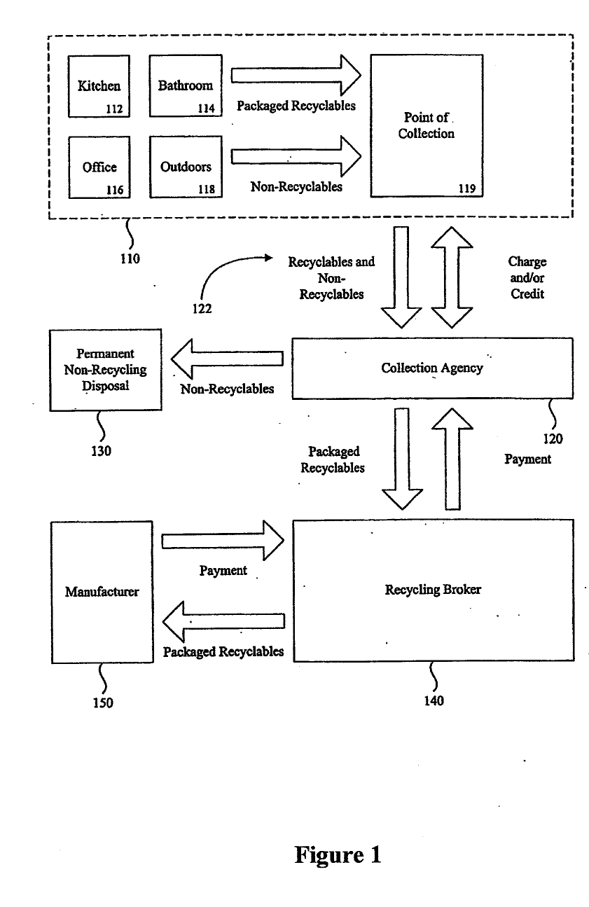

Referring to FIG. 1, there is block diagram illustrating the environment of an exemplary embodiment of the described method and system. In the example shown in FIG. 1, a household 110 is depicted as a waste generating entity. Of course, household 110 is merely one example of an entity that generates waste, which may be disposed of using the method and system of the present invention. Other waste generating entities that could benefit from the present invention include, for example, business offices, manufacturers, retailers and restaurants.

Household 110 includes a number of points of disposal. A point of disposal is a location at which waste is generated, particularly recyclable waste. A point of disposal is the first point at which waste is handled in accordance with the present invention. Exemplary points of disposal within household 110 include the kitchen 112, the bathroom 114, the office 116 and outdoor areas 118 such as the garage and the yard. Of course, these points of disposal are merely illustrative.

According to the exemplary embodiment, waste is sorted and packaged at each point of disposal and transported to a point of collection 119. Although in the exemplary embodiment waste is transported directly between the points of disposal 112, 114, 116 and 118 and the point of collection 119, in an alternate embodiment there may be one or more intermediate points of storage (not illustrated) at which waste is stored prior to collection. Non-recyclable waste may be packaged in a conventional manner. Recyclable waste, such as paper, metal, glass, plastics and some toxic materials, for example, are packaged into readily identifiable units. For purposes of this description, recyclable waste may be grouped into discrete units known as “Complete Unit of Recyclable” (hereafter referred to as a “CUR”, pronounced “CURE”).

A CUR provides a means for determining a per unit value for a discrete quantity of a particular recyclable. By bundling recyclable materials into readily identifiable, sorted, measured groups, each bundle of recyclable material may move efficiently and productively through a stream of recycling. The stream of recycling typically includes a series of sequential points through which recycled goods must travel in order to be recycled. The first point in the stream is the point of disposal 112, 114, 116 and 118. The second is the point of collection 119. The third is the point of exchange, and the fourth is the point of reuse. The point of collection 119 for household 110 is generally a “curb-side” pickup point. Of course, any location accessible to collection agency 120 will suffice, including, for example, a garage, a shed, an alley or a dumpster. In the exemplary embodiment, representatives of collection agency 120 travel to the point of collection 119, typically in a truck, and remove the disposed waste to be recycled or permanently discarded.

Collection agency 120 transports items that have not been identified as recyclable to a point of permanent non-recycling disposal 130. Typically, the point of permanent disposal is a landfill or incinerator. Collection agency 120 transports the packaged recyclables to a point of exchange 122. At the point of exchange, the packaged recyclables are traded for payment instead of being placed in a land fill or burned. At this point, a buyer and a seller meet to trade in CURs. For example, collection agency may have gathered several yellow 1-CUR bags of plastic at their originating points of collection 119. Collection agency 120 may market them to a recycler or recycling broker 140. In turn, recycling broker 140 markets the packaged recyclables to a manufacturer 150 to be converted for use into new products. At this point or reuse, units of CURs are recycled into other products that are then sold in other markets.

CUR Containers

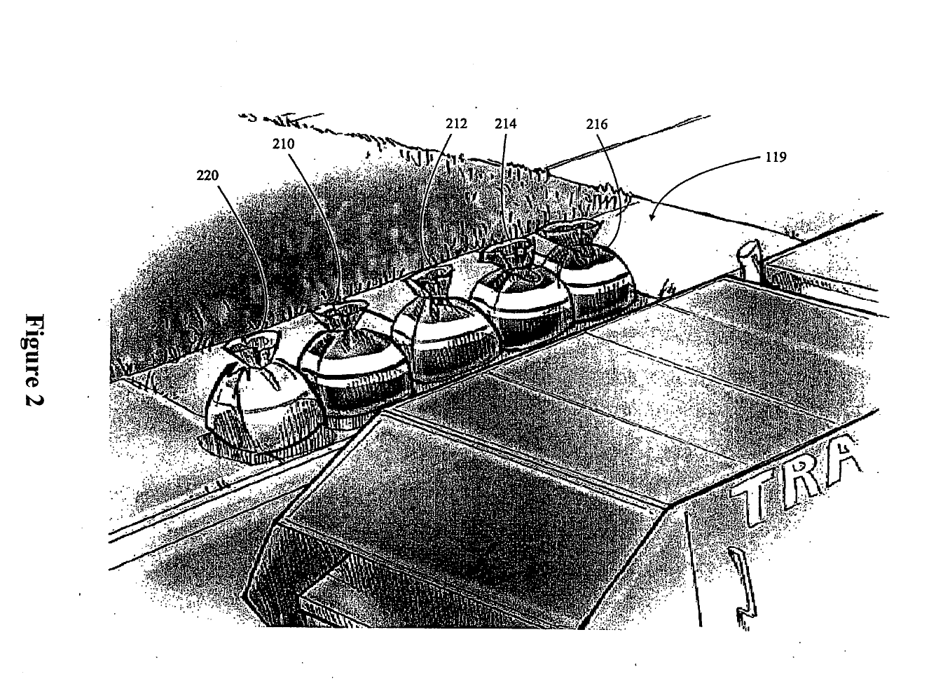

Referring now to FIG. 2, there is illustrated a pictorial view of the exemplary point of collection 119. As shown, exemplary point of collection 119 is a curbside location. The exemplary containers of the present invention are also illustrated. The illustrated point of collection 119 includes a bag of recyclable plastic 210, a bag of recyclable metal 212, a bag of recyclable glass 214, a bag of recyclable paper 216 and one or more bags of unidentified waste 220. In accordance with an exemplary embodiment of the present invention, each container of recyclable waste includes certain external characteristics. Namely, each container of recyclable waste includes indicia that enable one to readily identify the contents and the value of the container relative to other recyclable products. As previously described, the exemplary means for identifying the relative value of recyclables is using CURs, a specialized unit of measurement that is effectively a currency that allows for trading of recyclables.

Although the exemplary content and value identification means is written indicia of the material type and number of CURs contained within a container, there are numerous other means for accomplishing this. For example, a different color, as illustrated in Tables A and B below, represents different types of recyclable material and relative values thereof.

TABLE A
Recyclable Materials Table

| RECYCLABLE MATERIAL | COLOR INDICATOR |
|---|---|
| Plastic | Red |
| Metal | Green |
| Glass | Blue |
| Paper | Yellow |
| Toxic Materials | Black |
| Yard Waste | Brown |

TABLE B
CUR Value Table

| CUR VALUE | COLOR INDICATOR |
|---|---|
| 0.10 CUR | White |
| 0.25 CUR | Pink |
| 0.50 CUR | Purple |
| 0.75 CUR | Orange |
| 1.00 CUR | Light Blue |

Using the examples set forth in Tables A and B, an identification system is fashioned using the color of bags to denote the contents and the color of a stripe on a bag to denote a CUR value. For example, a red bag with a white stripe would contain 0.10 CUR worth of recyclable plastic. Following the same example, a blue bag with a light blue stripe would contain 1 CUR of recyclable glass. Other examples of means for indicating the contents and relative value of a bag of recyclables include, for example, bar-coded material and value information, informational stickers applied to a container, symbols representing recyclable materials and/or values. Of course, the present invention includes any convention identification means. The use of bar-coded or other electronically readable indicia enables a collection agent to automatically bill a consumer for trash collection using a computerized apparatus. Such an apparatus enables a collection agent to identify or electronically read an amount of non-recyclable trash and an amount of recyclable trash. A processor within the apparatus then applies charges and credits according to the amounts entered or electronically read. The apparatus then reports the change and credit to the consumer for payment or credit.

Preferably, users collect recyclable material at various points of disposal within a household or business. Users place appropriate containers, identifying the material and the value of a full container, at each point of disposal. In addition to readily identifying the contents and value, the containers of the present invention may be made from the recyclable material that they contain, to the extent commercially reasonable. This allows primary and secondary markets to value them by their approximate weight, an approximation of which is readily available by their individual appearance. Consequently, the containers of the present invention have certain characteristic that promotes future redeemability. Each container: (i) enables identification of the contents; (ii) enables identification of a relative value; (iii) promotes a market valuation; (iv) enables identification of an approximate weight (either explicitly or based on value); (v) is itself potentially recyclable, where commercially practicable; and (vi) promotes efficient future redemption.

CUR Collection Method

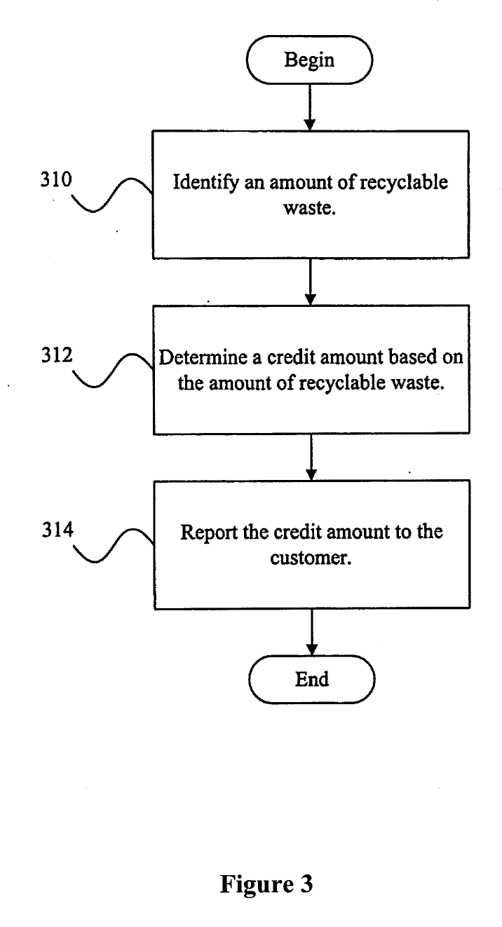

Referring now to FIG. 3, there is illustrated a functional flow diagram illustrating the primary steps employed according to an exemplary method of the present invention. A representative of collection agency 120 at the point of collection 119 typically performs the steps of the method. According to step 310, an amount of recyclable waste is identified. Preferably, the amount of recyclable waste is identified according to the indicia on each container of recyclable waste. Of course, other forms of identification are possible, such as weighing the amount of each type of recyclable waste, including for example, glass, plastic, metal and paper. At step 312, a credit amount is determined based on the amount identified at step 310. Preferably, the credit amount is determined based on a number of CURs of recyclable waste, regardless of the type of material. Of course, the credit amount could be determined in a number of ways, such as, for example, by applying a different value to each type of recyclable material, and applying each different value to specific weights identified at step 310. At step 314, the credit amount determined at step 312 is reported to the customer. Preferably, the credit amount is reported to the customer in connection with applying the credit to a financial account on the customer's behalf. In one embodiment, the credit is reported as an offset to a collection charge for the services of collection agency 120.

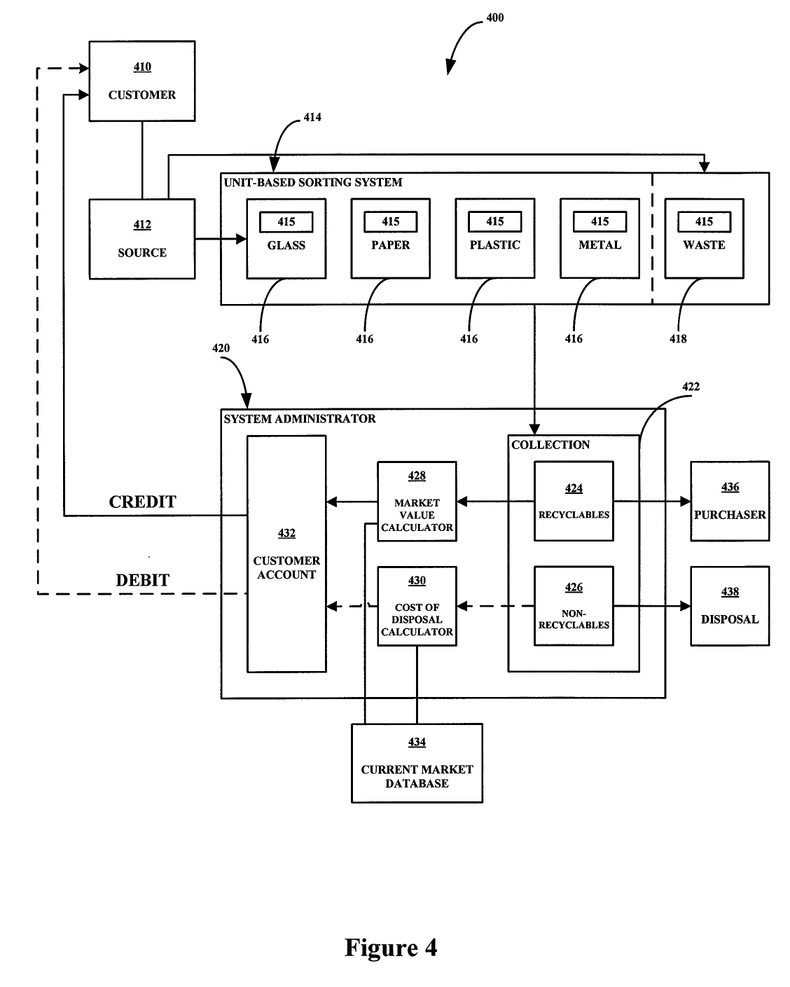

With reference now to FIG. 4, an alternate exemplary embodiment of this invention provides a comprehensive system 400 for managing recyclable and non-recyclable materials. This system includes at least one customer 410, typically a home or business owner; at least one source 412, e.g., a home or business, of recyclable material 424 of at least one type, such as, for example, glass, paper, plastic, and metal; a unit-based sorting system 414 for sorting the recyclable material by type; and a system administrator 420 for processing the recyclable and non-recyclable materials and crediting or debiting customer 410 for material that is either purchased or discarded. The system 414 for sorting the recyclable materials by type further includes a plurality of individual containers 416 for storing recyclable materials and at least one container 418 for collecting non-recyclable materials, e.g., common household waste or trash. Each of the containers 416 and 418 further includes at least one type of identifying indicia 415 relating at least in part to the contents of each container 416 and 418.

System administrator 420, which may be a single entity or multiple cooperative entities (e.g., public, private and/or governmental) further includes computer, electronic, digital or other means for creating and managing a customer account 432 for each of the at least one customers 410. System administrator 420 further includes collection means 422 for periodically gathering the recyclable and non-recyclable materials from the source 412, such a fleet of vehicles useful for collecting waste from homes and businesses. Collection means 422 also includes a means for measuring or otherwise determining the weight or other physical property of a filled container 416 and/or 418, such as a series of scales maintained by one or more entities within the system administrator. A market value calculator 428 provides a means for determining a current market value, by weight, volume, or other measure for each type of recyclable material collected from source 412 based on information gathered from a current market database 434, which may be a stand-alone database or a collection of commercial or private databases accessible by system administrator 420. Market value calculator 428, which may include a portable bar-code scanner or similar device, uses identifying indicia 415 to associate the contents of each container 416 with the current market value for a particular recyclable material 424, and then uses the measured weight and/or volume of each container 416 to calculate or otherwise determine a per unit value (i.e., a CUR) for each filled container 416. Once the “per unit” value has been determined, market value calculator 428 communicates with customer account 432 and credits at least a portion of each determined value to customer 410. Similarly, cost of disposal calculator 430 uses identifying indicia 415 to associate the contents of each container 418 with the current cost of disposing of non-recyclable waste, and then uses the measured weight and/or volume of each container 418 to calculate or otherwise determine the cost per unit for each filled container 418. Once the “per unit” cost has been determined, cost of disposal calculator 430 communicates with customer account 432 and debits customer account 432 or charges the cost to customer 410. System 400 typically includes a purchaser 436 for the CURs of recyclable materials 424, and purchaser 436 may be the system administrator itself or a separate commercial or private entity. System 400 also typically includes an entity 438 for effecting disposal of the non-recyclable materials 426. As will be appreciated by the skilled artisan, system administrator 420 may include, incorporate, or utilize any of a variety of known electrical, analog, and or digital processing and communications systems, devices, hardware, and software for executing the various aspects of system 400 for which the system administrator 420 is responsible. System administrator 420 will also typically include at least one computer system, at least one internal and/or external database, and at least one computer network.

In the exemplary embodiment of system 400, the recyclable materials 424 typically include glass, paper, plastic, metal or combinations thereof, and the non-recyclable materials 426 typically include common household trash, garbage, lawn waste, or other materials. The containers 416 for storing recyclable materials 424 and the non-recyclable materials 426 are typically plastics bags, paper bags, or combinations thereof and may be provided to the customer 410 by the system administrator 420. The containers 416 may also be made available as a commercial product sold by various vendors or retailers. The identifying indicia 415 typically include a computer-readable storage medium (e.g., a bar code), printed text, different colors that correspond to the type of recyclable or non-recyclable material, printed instructions, or combinations thereof. The computer-readable storage medium may contain information about the size of the container, volume of the container, contents of the container, user account, customer, or combinations of this information and other relevant information.

Again with reference to FIG. 4, an alternate exemplary embodiment of this invention provides a systematic method for managing recyclable and non-recyclable materials. This method includes identifying at least one customer 410, typically a home or business owner, wherein the customer 410 is or otherwise provides a source 412 of recyclable materials 424 of at least one type; providing a unit-based system 414 for sorting the recyclable materials 424 by type, wherein this system further includes a plurality of individual containers 416 for storing the recyclable materials 424, and wherein each container 416 further includes certain identifying indicia 415 relating at least in part to the contents of the container; creating and managing a customer-accessible customer account 432 for each of the at least one customers 410; periodically collecting the recyclable materials from the source 412; measuring the weight and/or volume of a container 416 or otherwise quantifying its contents when the container is filled with recyclable material; using an internal or external database 434 or other source of relevant information for determining a current market value, by weight and/or volume, for recyclable materials 424; using the identifying indicia 415 to associate the contents of each container 416 with the current market value for a particular recyclable material and using the measured weight or other quantitative measure of each container 416 to determine a per unit value (i.e., a CUR) for each filled container; and crediting at least a portion of each determined value to the appropriate customer account 432. This exemplary method also typically includes the step of identifying a purchaser 436 for the CURs of recyclable materials 424.

The exemplary systematic method for managing recyclable and non-recyclable materials also typically includes providing at least one source 412 of non-recyclable materials 426, which is typically the same as the at least one source 412 of recyclable materials 424; periodically collecting the non-recyclable materials from the source 412; separating the non-recyclable materials 426 from the recyclable materials 424; determining a cost for disposing of the collected non-recyclable materials; and debiting the cost of disposing of the non-recyclable materials against the appropriate customer account 432. This method may also include the steps of identifying an entity 438 for disposing of the non-recyclable materials 426; providing instructions, wherein the instructions are printed on the inside of the containers; and/or printing information on the exterior of the containers, wherein the information further includes advertising, public service announcements, or other subject matter.

In this method, the recyclable materials 424 typically include glass, paper, plastic, metal or combinations thereof, and the non-recyclable materials 426 typically include common household trash, garbage, lawn waste, or other materials. The containers 416 and 418 are typically plastics bags, paper bags, or combinations thereof. The identifying indicia 415 may further include a computer-readable storage medium (e.g., a bar code), printed text, different colors that correspond to the type of recyclable material, printed instructions, or combinations thereof. The computer-readable storage medium may contain information about at least one of following: the size of the container, volume of the container, contents of the container, user account, the customer, and other information.

Practical Advantages of the Invention

An advantage of the present invention is that it addresses a previously unrecognized reason that trash production continues to grow faster than present recycling efforts. Namely, trash production is perceived to be free and recycling is considered to be an expense. Producing and disposing of a product or packaging is not considered a cost to the purchaser. The cost is neither implicitly imposed, such as through higher product costs. Nor is the cost explicitly imposed, such as through disposal fees. Although a portion of municipal taxes are used for local trash services and businesses are charged for their production, the typical consumer perceives no direct correlation between the disposal of a package and the cost of such disposal. Consequently, there is no incentive for a consumer to recycle, and there is no disincentive for a consumer to permanently dispose of waste. The absence of market forces from the disposal decision causes increased MSW compared with recycling efforts. The method and system of the present invention reduces MSW production and increases recycling by financially encouraging consumers to recycle and preferably financially discouraging consumers to permanently dispose of waste. Consequently, use of the present invention results in decreased permanent disposal and increased recycling.

Another advantage of the present invention is that it encourages the reduction of the cost of waste removal. Yet another advantage of the present invention is that it encourages more complete recycling than prior art recycling methods and systems.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1) A system for managing recyclable and non-recyclable materials, comprising:
(a) at least one customer;
(b) at least one source of recyclable materials of at least one type;
(c) a system for sorting the recyclable materials by type;
(i) wherein the system for sorting the recyclable materials by type further includes a plurality of individual containers for temporarily storing the recyclable materials; and
(ii) wherein each container further includes identifying indicia relating to the materials in the container; and
(d) a system administrator, wherein the system administrator further includes:
(i) means for creating and managing a customer account for each of the at least one customers;
(ii) means for collecting the recyclable materials from the source;
(iii) means for measuring at least one physical property of a filled container;
(iv) means for determining a current market value for the recyclable materials;
(v) means for using the identifying indicia to associate the contents of each container with the current market value for a particular recyclable material and using the at least one measured physical property of each container to determine a per unit value for each filled container; and
(vi) means for crediting at least a portion of each determined per unit value to the appropriate user account.

2) The system of claim 1, further comprising a purchasing entity for purchasing the recyclable materials from the system administrator.

3) The system of claim 1, further comprising:
(a) at least one source of non-recyclable materials; and
(b) wherein the system administrator further comprises:
(i) means for collecting the non-recyclable materials from the source;
(ii) means for separating the non-recyclable materials from the recyclable materials;
(iii) means for determining a cost for disposing of the non-recyclable materials collected from the source; and
(iv) means for debiting the cost of disposing of the non-recyclable materials against the appropriate user account.

4) The system of claim 3, further comprising an entity for disposing of the non-recyclable materials.

5) The system of claim 1, wherein the at least one source of recyclable materials is selected from the group consisting of a home or business.

6) The system of claim 1, wherein the recyclable materials are selected from the group consisting of metal, glass, paper, plastic and combinations thereof.

7) The system of claim 1, wherein the containers for storing recyclable materials are selected from the group consisting of plastics bags, paper bags, and combinations thereof.

8) The system of claim 1, wherein the identifying indicia is selected from the group consisting of computer-readable storage media, printed text, different colors, printed instructions, and combinations thereof.

9) The system of claim 8, wherein the computer-readable storage medium includes information about at least one of the size of the container, the volume or the contents of the container, the user account, and the customer.

10) The system of claim 8, wherein the computer-readable storage medium is a bar code.

11) The system of claim 1, wherein the system administrator is a single public, private, or governmental entity.

12) The system of claim 1, wherein the system administrator further comprises a plurality of separate business entities and governmental entities.

13) The system of claim 1, wherein the system administrator further comprises at least one computer system, at least one database, and at least one computer network.

14) The system of claim 1, wherein the system administrator is a purchaser of the recycled materials.

15) A method for managing recyclable and non-recyclable materials, comprising:
(a) identifying at least one customer;
(b) providing at least one source of recyclable materials of at least one type;
(c) providing a system for sorting the recyclable materials by type;
(i) wherein the system for sorting the recyclable materials by type further includes a plurality of individual containers for temporarily storing the recyclable materials;
(ii) wherein each container further includes identifying indicia relating to the contents of the container; and
(d) creating and managing a user account for each of the at least one customers;
(e) collecting the recyclable materials from the source;
(f) measuring the weight of a filled container;
(g) determining a current market value, by weight, for the recyclable materials;
(h) using the identifying indicia to associate the contents of each container with the current market value for a particular recyclable material and using the measured weight of each container to determine a per unit value for each filled container; and
(i) crediting at least a portion of each determined per unit value to the appropriate user account.

16) The method of claim 15, further comprising the step of identifying a purchaser for the recyclable materials.

17) The method of claim 15, further comprising:
(a) providing at least one source of non-recyclable materials, wherein the source of the non-recyclable materials is substantially the same as the at least one source of recyclable materials;
(b) separating the non-recyclable materials from the recyclable materials;
(c) collecting the non-recyclable materials from the source;
(d) determining a cost for disposing of the non-recyclable materials collected from the source; and
(e) debiting the cost of disposing of the non-recyclable materials against the appropriate user account.

18) The method of claim 17, further comprising the step of identifying an entity for disposing of the non-recyclable materials.

19) The method of claim 15, wherein the recyclable materials are selected from the group consisting of metal, glass, paper, plastic and combinations thereof.

20) The method of claim 15, wherein the containers for storing recyclable materials are selected from the group consisting of plastics bags, paper bags, and combinations thereof.

21) The method of claim 15, wherein the identifying indicia are selected from the group consisting of computer-readable storage media printed text, different colors, printed instructions, and combinations thereof.

22) The method of claim 21, wherein the computer-readable storage medium includes information about at least one of the size of the container, the volume or the contents of the container, the user account, and the customer.

23) The method of claim 21, wherein the computer-readable storage medium is a bar code.

24) The method of claim 15, further comprising the step of providing instructions, wherein the instructions are provided on the inside of the containers.

25) The method of claim 15, further comprising the step of printing information on the exterior of the containers, wherein the information further includes advertising.
